(19) United States
(12) Patent Application Publication
(10) Pub. No.: US 2023/0027897 A1
(43) Pub. Date: Jan. 26, 2023

(54) RAPID DEVELOPMENT OF USER INTENT AND ANALYTIC SPECIFICATION IN COMPLEX DATA SPACES

(71) Applicant: International Business Machines Corporation, Armonk, NY (US)

(72) Inventors: Gigi Y. C. Yuen-Reed, Tampa, FL (US); Kimberly Dunwoody, Parker, CO (US); Subhro Das, Cambridge, MA (US); Tricia Garrett, Raleigh, NC (US)

(21) Appl. No.: 17/385,750

(22) Filed: Jul. 26, 2021

(51) Int. Cl. G06N 5/04; G06N 5/02; G06F 40/295

(52) U.S. Cl. CPC G06N 5/04; G06N 5/022; G06F 40/295

(57) ABSTRACT

A method for creating a question answering system includes receiving user stories, wherein each of the user stories is structured as a plurality of first phrasal entities within a template; applying a Natural Language Processing to discover first data relationships between the first phrasal entities and first context relationships between the first phrasal entities; constructing a knowledge graph that captures second data relationships and second contextual relationships of a plurality of second phrasal entities; enriching the KG by linking the first phrasal entities to the second phrasal entities to form enriched phrasal entities in the KG; receiving a selection of ones of the enriched phrasal entities for completing a story template; identifying a technical requirement based on the selection of the enriched phrasal entities; and training a model matching at least one of the user stories to the technical requirement.

### BACKGROUND

The present disclosure relates generally to a machine learning, and more particularly to cataloging, understanding, and accelerating the establishment of user analytic intent and development requirements within complex data spaces.

The creation of conventional analytic wizards configured to classify data typically focuses on parsing Natural Language Processing (NLP) search to retrieve data from multiple data sources to be displayed in a data visualization or tabular format. Classification methods can also be used to create archetypes by combining data from multiple sources. Some conventional configurable analytics models and visualizations enable end users the flexibility to turn on/off “switches” or setting parameter values to meet different information needs. Numerous conventional systems recommend, or automatically create, visualizations based on theoretical foundations such as the data model and the visualization reference model. Data property-based systems rely on data characteristics to choose a visual representation.

### SUMMARY

According to some embodiments of the present invention, a method for creating a question answering system includes receiving a plurality of user stories, wherein each of the user stories is structured as a plurality of first phrasal entities within a template (MLSS), applying a Natural Language Processing (NLP) to discover first data relationships between the first phrasal entities and first context relationships between the first phrasal entities, constructing a knowledge graph (KG) that captures second data relationships and second contextual relationships of a plurality of second phrasal entities extracted from a data corpus, enriching the KG by linking the first phrasal entities to the second phrasal entities to form a plurality of enriched phrasal entities in the KG, receiving a selection of ones of the enriched phrasal entities for completing a story template, identifying a technical requirement based on the selection of the ones of the enriched phrasal entities, and training a model matching at least one of the user stories to the technical requirement, wherein the model is stored in an analytic task library.

According to at least one embodiment, a computer-implemented method of operating a question answering system, the method comprises receiving a plurality of user stories, wherein each of the user stories is structured as a first plurality of phrasal entities within a template (MLSS), discovering first data relationships between the phrasal entities, discovering first context relationships between the phrasal entities, accessing a knowledge graph (KG) that captures second data relationships and second contextual relationships of a second plurality of entities, enriching the KG by linking the first phrasal entities to the second entities to form a plurality of enriched phrasal entities in the KG, providing a display of select ones of the enriched phrasal entities, and receiving a selection of ones of the enriched phrasal entities displayed, wherein the selected enriched phrasal entities complete a story template.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of a computer program product including a computer readable storage medium with computer usable program code for performing the method steps indicated. Furthermore, one or more embodiments of the invention or elements thereof can be implemented in the form of a system (or apparatus) including a memory, and at least one processor that is coupled to the memory and operative to perform exemplary method steps. Yet further, in another aspect, one or more embodiments of the invention or elements thereof can be implemented in the form of means for carrying out one or more of the method steps described herein; the means can include (i) hardware module(s), (ii) software module(s) stored in a computer readable storage medium (or multiple such media) and implemented on a hardware processor, or (iii) a combination of (i) and (ii); any of (i)-(iii) implement the specific techniques set forth herein.

Techniques of the present invention can provide substantial beneficial technical effects. For example, one or more embodiments may provide for:

cataloging, understanding, and accelerating the establishment of user analytic intent and development requirements within complex data spaces; and

automatically configuring a question answering system.

These and other features and advantages of the present invention will become apparent from the following detailed description of illustrative embodiments thereof, which is to be read in connection with the accompanying drawings.

### BRIEF DESCRIPTION OF THE DRAWINGS

Preferred embodiments of the present invention will be described below in more detail, with reference to the accompanying drawings:

FIG. 1 depicts a cloud computing environment according to an embodiment of the present invention;

FIG. 2 depicts abstraction model layers according to an embodiment of the present invention;

FIG. 3 depicts a composable analytic architecture according to an embodiment of the present invention;

FIG. 4 is an illustration of a method for operating a composable analytic architecture according to an embodiment of the present invention;

FIG. 5 is an illustration of interconnected data systems according to an embodiment of the present invention;

FIG. 6 is an illustration of a method for determining analytic intent according to an embodiment of the present invention;

FIG. 7 is an illustration of a collaborative framework supporting the answering of a question according to an embodiment of the present invention;

FIG. 8 illustrates mappings of a Mad-lib User Story (MUS) to an analytic task according to an embodiment of the present invention;

FIG. 9 illustrates an example user interface according to an embodiment of the present invention;

FIG. 10 is an example implementation of a user interface (UI) and method according to an embodiment of the present invention;

FIG. 11, a method for creating a question answering system according to an embodiment of the present invention; and

FIG. 12 depicts a computer system that may be useful in implementing one or more aspects and/or elements of the invention.

### DETAILED DESCRIPTION

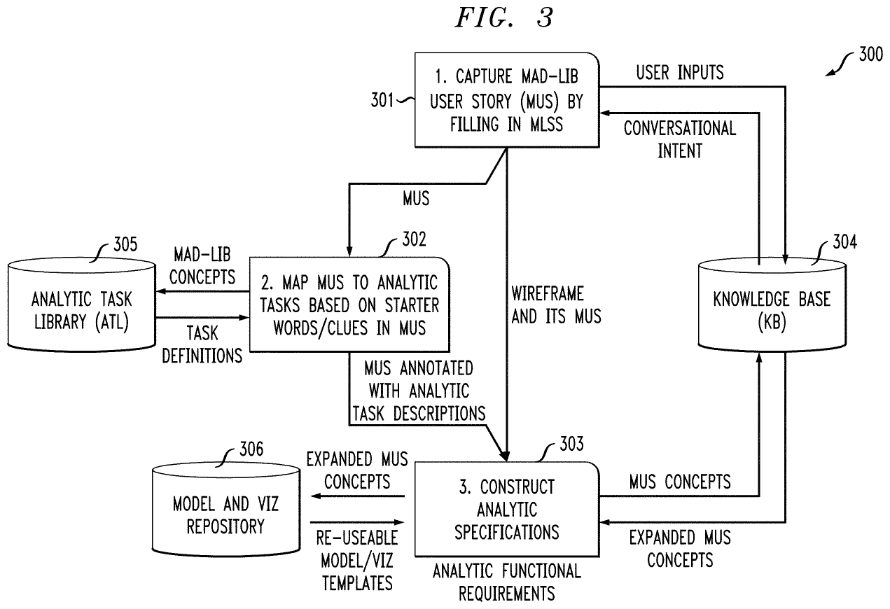

According to example embodiments, systems and methods described herein enable the rapid sharing of expert knowledge across multiple disciplines towards a shared mental model and composable analytic architecture, which accelerates time-to-market for goods and services (see FIG. 3).

Work on narrow, linear, use cases can be complex, time-consuming, and costly. Moreover, due to the complexity and cost of uncovering insights within data rich industries, there is a need for AI systems configured to answer narrow questions. Additionally, data visualization methods have allowed end users to explore data to answer some adjacent questions, however these experiences are often undertaken by Subject Matter Experts (SME) in a single area of expertise.

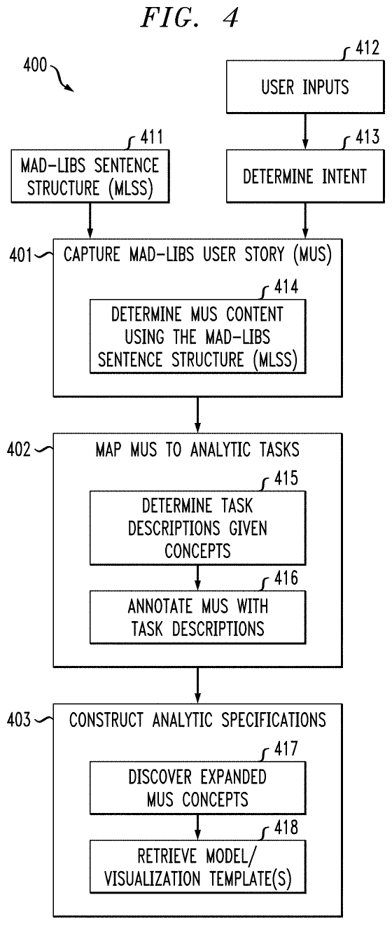

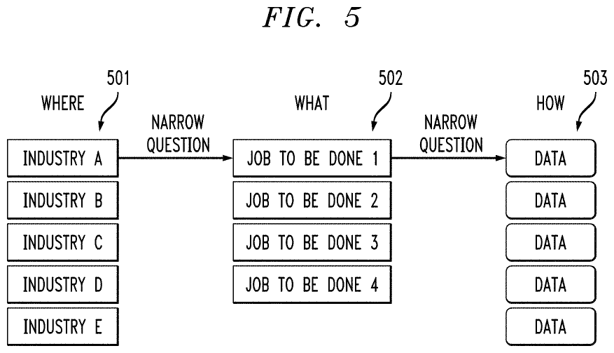

According to some embodiments, a repeatable analytic workflow enables rapid retrieval of insights to meet an analytic intent. The workflow facilitates rapid data-to-analytic intent mapping and metadata for internal/external experiences and data visualization mapping (see FIG. 4). According to at least one embodiment, the development of analytic requirements (see FIG. 5) can be accelerated, and users can be guided in the composition of analytic insights according to intent of changing business needs.

The present application will now be described in greater detail by referring to the following discussion and drawings that accompany the present application. It is noted that the drawings of the present application are provided for illustrative purposes only and, as such, the drawings are not drawn to scale. It is also noted that like and corresponding elements are referred to by like reference numerals.

In the following description, numerous specific details are set forth, such as particular structures, components, materials, dimensions, processing steps and techniques, in order to provide an understanding of the various embodiments of the present application. However, it will be appreciated by one of ordinary skill in the art that the various embodiments of the present application may be practiced without these specific details. In other instances, well-known structures or processing steps have not been described in detail in order to avoid obscuring the present application.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

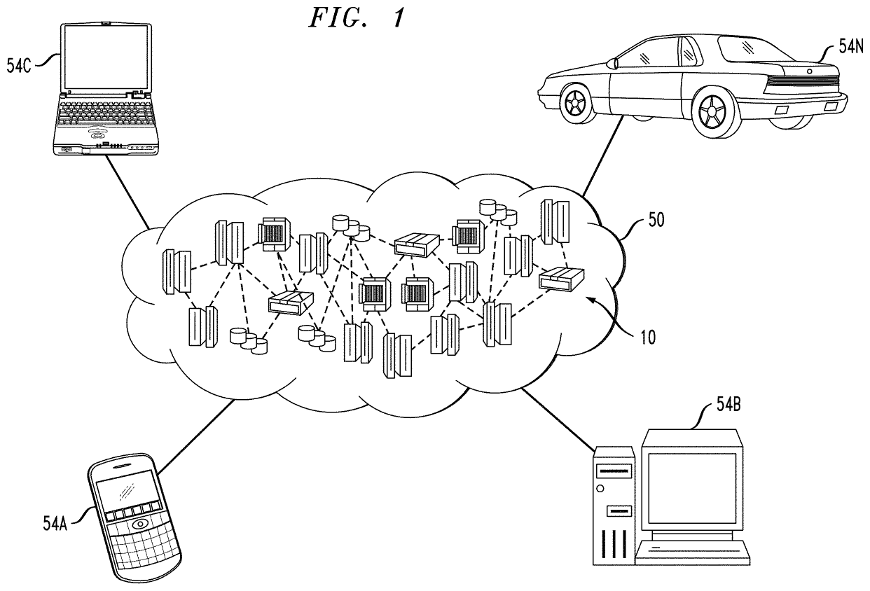

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

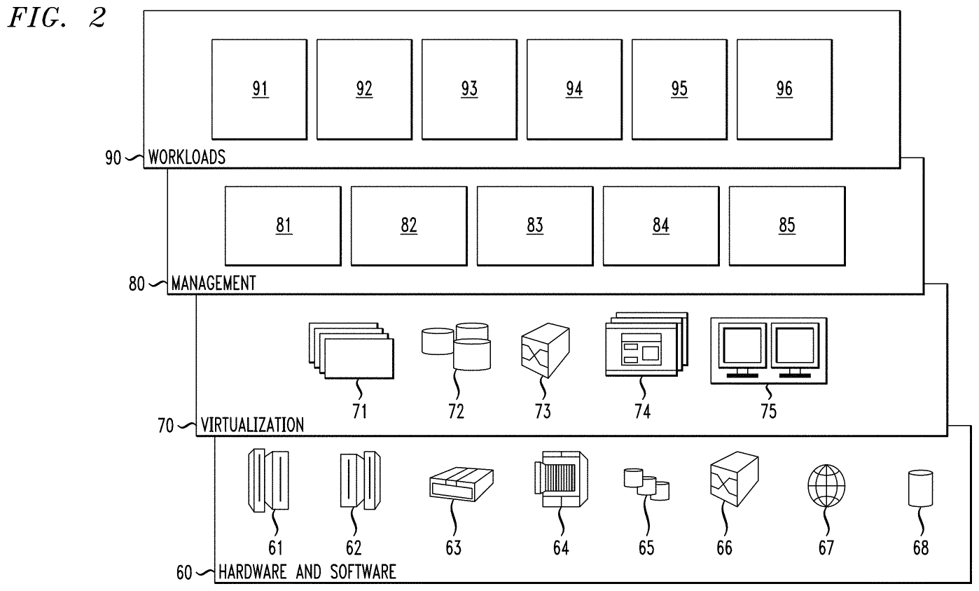

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and automatically configuring a question answering system 96.

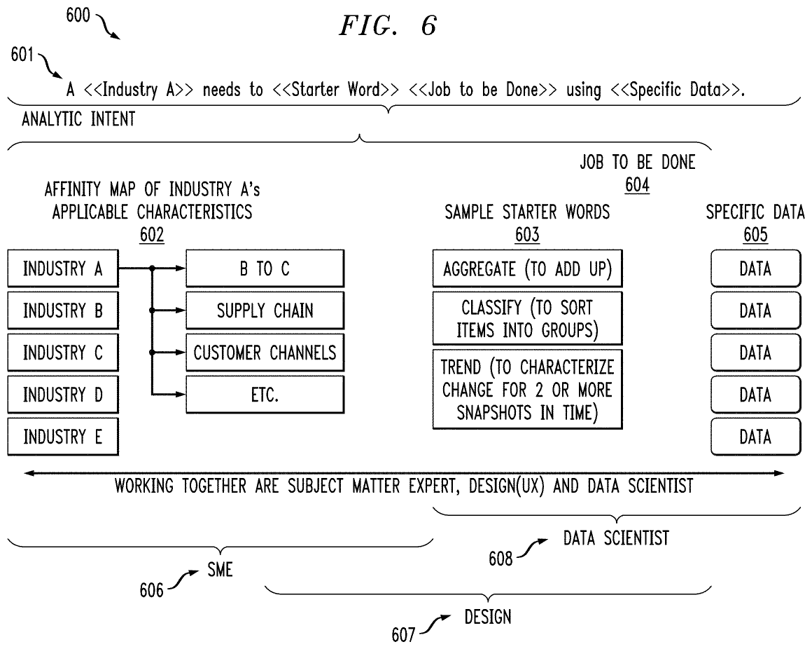

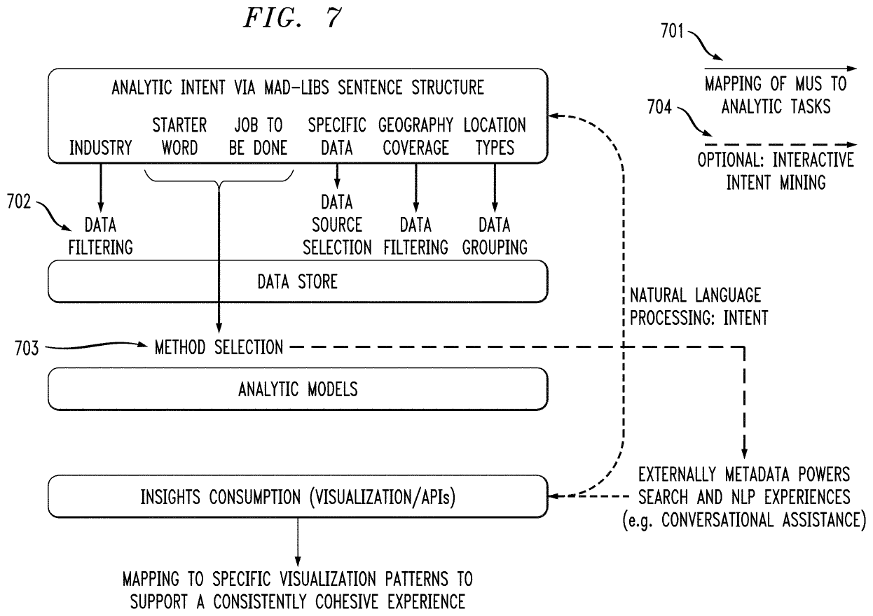

Within a complex system (e.g., a questions answering system), the interactions between components of the system and the data they generate can make it difficult to extract a clear analytic intent (see FIG. 5) for user's of the system. The user's analytic intent describes an expected function of an analytic (e.g., a widget, application, system, etc.) to support the user's ability to inform multivariate decisions, identify a pattern, and/or trend multivariate data across multiple dimensions. According to some embodiments, the mining of analytic intent 704 (see FIG. 7) in a complex interconnected data system requires common knowledge of the involved industries/disciplines (where), analytic tasks to be done (what), and the data needed to inform analytic intent (how) (see FIG. 6).

By way of example, data democratization (e.g., making data accessible to a wide range of users) has led to advancements across various data intensive applications. For example, in this context the field of healthcare has adopted visual data mining tools for accessing and analyzing data (e.g., to determine a breakdown of costs associated with conditions of different procedures). Conversational experiences aimed at understanding user intent have arisen in parallel with data democratization. These conversational experiences seek to infer a user's analytic intent from conversational utterances using, for example, using Natural Language Processing (NLP). Further, according to some examples, conversational utterances can include data captured from a chatbot, chat logs, emails, other electronic communication mediums, etc.

Without an effective way to capture and represent analytic intent in a repeatable manner, product development teams invest significant time iterating on use case needs and their mappings to analytic requirements. The resulting analytic requirements tend to lack specificity. The lack of specificity can cause miscommunications and increase development times. In addition, without a common analytic intent capture approach, each use case often leads to customized technical implementations, which limits the re-useability of the analytical components across product lines.

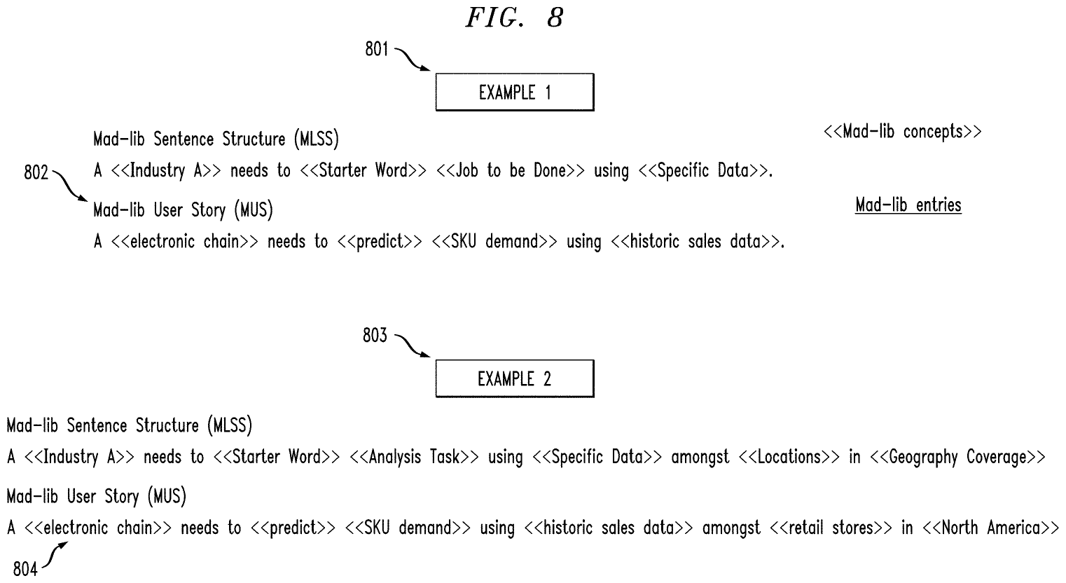

According to some examples of the present invention, a Mad-lib Sentence Structure (MLSS) is a template, including concepts for content or entities (e.g., denoted by <<concept>> in a MLSS), and a Mad-libs User Story (MUS) is a MLSS that has been populated by select content or entities (e.g., denoted by <<entity>> in a MUS). FIG. 8 shows examples of MLSS and MUS. For example, in Example 1, 801, an MLSS includes four concepts, including a first concept <<Industry A>>, and a MUS includes a populated first concept <<electronic chain>>.

According to some embodiments of the present invention and FIG. 3, a system 300 includes a capture module 301, a map module 302, and a construction module 303. The system 300 further includes a knowledge base (KB) 304 storing a knowledge graph, an analytic task library (ATL) 305, and a model and visualization repository 306. According to some examples, the system 300 functions to output an analytic specification and select a visualization for the analytic specification.

According to some embodiments, the knowledge base 304 captures data relationships and contextual relationships of entities derived from a data corpus and from continued use of the system, which introduces new data. According to some embodiments, the knowledge base 304 supports the development of MUS by the capture module 301 by providing a word cloud (e.g., clusters of highly related entities) and the derivation of user intent in an interactive scenario. For example, user intent is used to select entities that can be placed in a MLSS to create a MUS.

According to some embodiments, the knowledge base 304 can be developed by ingesting a published ontology of entities in a domain, analyzing a data model of analysis datasets, analyzing metadata of analytic methods (e.g., Machine Language (ML) models, visualization templates), etc. In some embodiments, the knowledge base 304 is developed by ingesting/analyzing data from a plurality of different sources, which can be from the same or different domains.

According to some embodiments, the knowledge base 304 can be further enhanced by applying NLP on metadata, data/analytic descriptions, and/or mining statistical relationships of data elements in the analysis datasets. It should be understood that the analysis datasets, as used herein, distinguish from training datasets.

According to some embodiments, the knowledge base 304 comprises a knowledge graph of entities. These entities can be grouped. For example, entities can be grouped by industry type, starter word(s), job to be done, dataset names, etc. According to some embodiments, entities in the knowledge graph are connected by links, which are determined by using the MUS in the capture module 301 as training data.

According to some embodiments, this training includes incorporating analytical intents, which can be added by SME, to the knowledge graph. Then for test data (e.g., data of a real-world application), the knowledge base 304 can be leveraged to create a connection to the previously trained analytical intents.

Accordingly to some embodiments, the knowledge graph and domain knowledge can grow with the addition of new analysis datasets. For example, a new dataset added to the knowledge graph can include a comprehensive data dictionary, which can include descriptions of the data fields and in some cases corresponding summary statistics. Accordingly, the knowledge graph can be updated to include new information.

Accordingly to some embodiments, the analytic task library 305 captures the actions comprising analytic tasks such as enabling data selection and curation (e.g., analytic action descriptions). Analytics tasks include actions needed to enable data selection, data curation, and method development processes. Example analytic tasks can include summarizing data by geography, calculating an average of a parameter, etc. The analytic task library 305 supports the analytic specification development by allowing the user to navigate and identify relevant actions for analytic tasks per the MUS.

Example analytic tasks in analytic task library 305 can be categorized as, for example:

Data Selection: using the MUS content to aid in making a selection (e.g., a data source);

Data Curation including:
Data Filtering: using the MUS input to aid in establishing filtering criteria to create subset of data; and
Data Grouping: using the MUS input to aid in the determination of grouping criteria to create aggregated data;

Method Development (including method selection): using the MUS input to aid in selecting an analytic method selection process. Example analytic methods include methods of performing a visualization, an analytic model, etc.

Accordingly to some embodiments, the analytic task library 305 can be improved over time as the use cases, analytics needs, and analytic technology are added.

Referring now to FIG. 4 and a method 400 for operating a composable analytic architecture according to an embodiment of the present invention, the capture module 301 captures a MUS at 401, the map module 302 maps the MUS to analytic tasks at block 402, and the construction module 303 constructs an analytic specification at block 403.

According to some embodiments, at block 401, the capture module 301 receives a selection of one or more Mad-lib Sentence Structures (MLSS) 411, user inputs 412 such as conversational inputs from a chatbot, and an indication of intent of the user 413. According to some embodiments, the intent of the user 413 can be determined using the user input 412, for example, using a trained classifier. Taking these inputs, the capture module 301 determines MUS content using the selected MLSS, wherein a set of sample MUS are developed (see FIG. 8, MUS 802 and 804).

According to at least one embodiment, one or more MLSS is provided by the system 411. Examples of MLSS are shown in FIG. 8 (801 and 803). The MLSS includes one or more concepts. The concepts can be identified by appropriate characters, e.g., “<< >>”, that are identifiable by the system.

According to some embodiments, the capture module 301 samples ways to construct an initial MUS. For example, an initial MUS sentence can be expressed as: A <<Business Model>> <<Industry Sector>> needs to <<Starter Words>> <<description of job to be done>> for its <<Location Types>> using <<Available Data & Analytics>>.

The map module 302 develops the initial MUS. The development process is illustrated in the following three different developments of a selected MLSS:
1) A B2C <<any industry>> needs to compare their customer's pre-COVID and post-COVID purchasing power for its retail locations using data: Retail Store Info, Transaction Data, News Searches, Mobility, Employment & Unemployment, New Cases).
2) A B2C <<any industry>> needs to compare their business operations by current unemployment for care giver jobs by geographic region to staff operations using data: employment & unemployment.
3) Focused on employee health and availability a B2B <<any industry>> needs to monitor/trend the overall workforce risk, infection rate and availability for All Locations and All Orgs in order to assess the effectiveness of current policies and recommend changes based on the data in their dashboard: RTWA Workpass Status, Counts, etc., RTWA Workforce availability (˜transmission risk among employees), Number of people who have been turned red and returned to work after quarantine, WCM, Case worker Time to First Contact, Case Volume by Status).

Shown in the examples, static text such as “need to” and “for its” and “using” is not changed, while the variables, designated as << >>, are filled in. It is apparent from the examples, that the development of the initial sentence is flexible. This development is a human directed task.

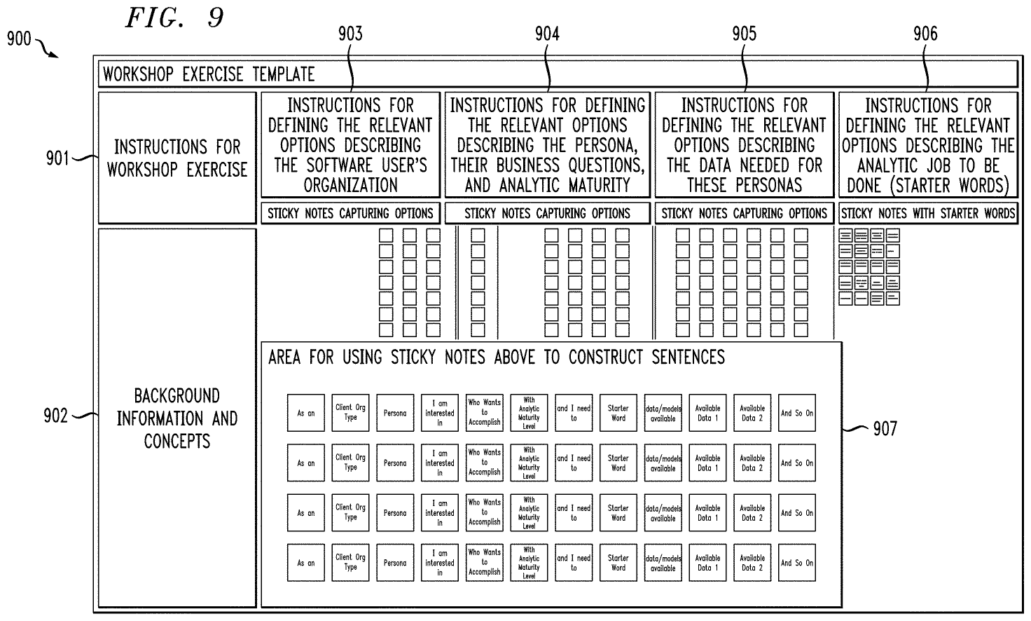

The map module 302 facilitates an enterprise design thinking session (see FIG. 9), e.g., with a SME or design and data scientist, to construct an initial knowledge graph (KG) to be stored in the knowledge base 304.

According to some embodiments and referring to FIG. 9, the map module 302 causes an enterprise design thinking session UI 900 to be displayed including one or more widgets (or UI elements), including user supplied instructions 901, background information and concepts 902, sets of pre-defined entity groups 903-906, an a sandbox for construction of sentences 907.

At block 414, the capture module 301 develops the MUS as-is or as an expanded MUS. According to some embodiments, starter words in the knowledge graph are well-suited for data visualization and machine learning. For example, analytic starter words are mapped to one or more data visualizations and analytic actions that comprise analytic tasks. For example, a timeline is a well-regarded choice of data visualization for the starter word “trend,” whereas a pie chart is not. In another example, the starter word “classify” can be mapped to the analytic action of “partitioning” the items in a data set and a histogram data visualization. The system can learn these mappings using a corpus of knowledge, including, for example, prior user selections.

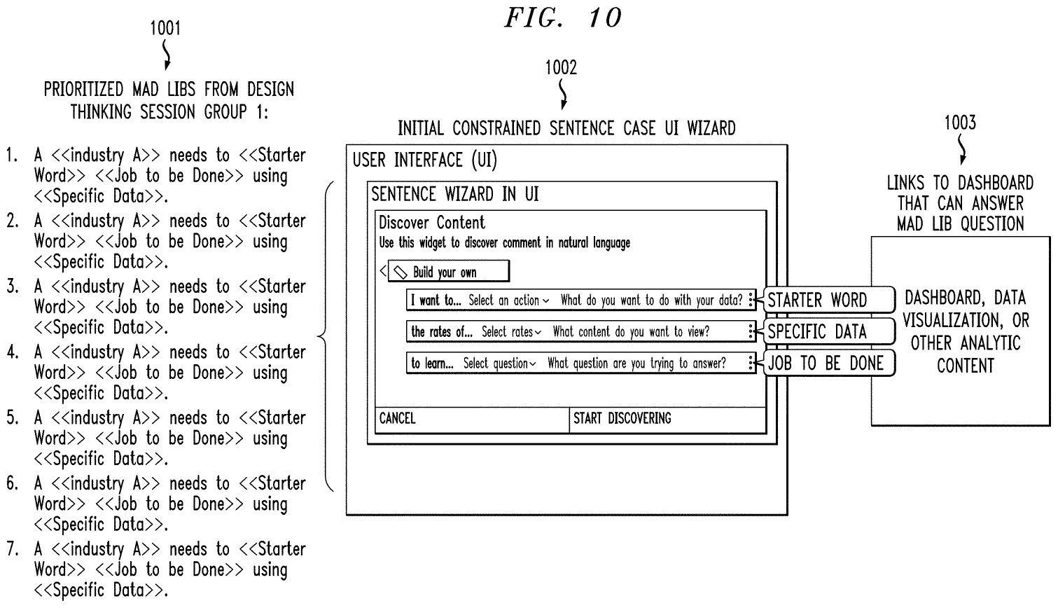

According to some embodiments, at block 414, the capture module 301 groups MUS based on an understanding of the user intent determining from the user input (i.e., on a discovered/mined intent of the user 413), and the grouping is used as a basis for a specific user interface, which can be supported by an intent-specific wizard (see FIG. 10). More particularly, a list of different MLSS 1001 are selected, prioritized, e.g., based on a confidence score, and provided to a user interface (UI) wizard 1002 for manipulation by the user. In one example, an MUS is selected for a group based on similarity in one or more of the user inputs. One example selection logic includes grouping MUS by industry (e.g., healthcare vs. media). Another example selection logic includes grouping MUS by starter word (e.g., all of the MUS that involve identifying a “trend” can be grouped together, regardless of industry).

At block 401, the capture module 301 designs wireframes to support analytic development at 303/402. Wireframes can be derived directly from the MLSS, allowing users to navigate to specific dashboards based on the analytic intent of the respective MLSS. In one example, the navigation is facilitated by metadata or a lookup table that maps a MUS (e.g., user inputs) to a dashboard. MUS can be directly derived from wireframes through the UI wizard 1002, wherein a user supplies data input or data selections for the variables (e.g., denoted by “<< >>”).

According to some embodiments, at block 401, the capture module 301 operates to further mature the knowledge graph(s) as the number of MUS grows. For example, as additional MUS are made available through the UI wizard 1002, e.g., as users create new MUS, these new MUS can be directly translated/mapped into user intents. For example, the MUS, created by a user, can be mapped to the intent via appropriate NLP or Knowledge-Based model. In an example interactive scenario, when a user makes a query, a topic model (e.g., Latent Dirichlet Allocation (LDA)) is invoked to map queries to the entities of the knowledge graph. Once the entities are identified, then the knowledge graph, with its analytic intent linkages, serves as the module for identifying the analytic intent and returns related data fields cutting across multiple datasets (e.g., entities found in the knowledge graph and/or analytic content such as dashboards, data, etc., based on the entities).

According to some embodiments, at 402 the map module 302 maps the MUS to analytic tasks. For example, for each MUS, the map module 302 analyzes the initial mad-lib concepts (i.e., the concepts that were replaced by the selected entities) and identifies a matching analytic task in the analytic task library 305. For example, the map module 302 determines task descriptions given the concepts at block 415 and annotates the MUS with the task descriptions at block 416. According to one example, the matching of the analytic task can be performed by leveraging NLP techniques like named entity recognition (NER) of concepts and normalization to the analytic tasks. In FIG. 7, the mapping is illustrated by the arrows 701. The concept-to-task mapping can be one-to-one, one-to-many, or many-to-many. For example, the <<industry>> concept informs a “Data Filtering” task at 702. In another example, the <<starter word>> and <<job to be done>> concepts together inform “Method Selection” at 703.

According to some embodiments, the construction module 303 constructs an analytic specification at 403. According to one example, these analytic specifications are include functions such as Categorize, Classify, Recognize, Compare and Contrast, Correlate (relationship), Cluster or Group (relationship), etc. For each wireframe, the construction module 303 pulls up corresponding MUS (or group of MUSs), looks up similar concepts for all the Mad-lib entities using the knowledge graph. According to one example, similarity can be determined by looking for a direct match to a concept in the knowledge graph (e.g., a same word or a word synonymous with user input). In another example, similarity is determined by looking at adjacent nodes (e.g., concepts related to this concept) in the knowledge graph. For each analytic task, the construction module 303 constructs analytic action specifications (e.g., functions to be done based on the given data). According to some embodiments, these specifications are used as technical requirements for analytic development teams, or align with an automated analytic pipeline to execute the actions like a mad-lib wizard.

According to some embodiments, at 403, the construction of analytic action specifications includes selecting data, curating the data, and developing the data. The selection, curation, and development are used to discover expanded MUS concepts at blocks 417 and 418.

According to some embodiments, at 417, the selection method includes searching for “Data Selection” concepts in the data model metadata as a way of determining which dataset(s) to further investigate for analytic development. For example, given a “Data Selection” action on the phrase “Mobility Data,” the system searches the knowledge graph (or some other data source that has been processed by the system) to find all data sources with “mobility” in their meta-data. For example, the method can search for Mobility data (e.g., Google Mobility data, Apple Mobility data, etc.) on the web. According to one example, the method can look for structured/unstructured data sources that are already processed for the system. According to at least one embodiment, the searching is initially performed on data sources that are already processed for this system, and then on unprocessed data, e.g., the Internet.

According to some embodiments, at 417, the curation method includes the analysis of “Data Filtering” concepts to identify the data field(s) and data value(s) for filtering. For example, a “Data Filtering” action on the phase “West Coast” under Geography Coverage, the knowledge base provides similar concepts to “West Coast” (which may include California that is related to State, Seattle that is related to City, etc.), and the similar concepts form the basis of the data filtering criteria. The analysis of the “Data Grouping” concepts identifies the data field(s) and the data value(s) to aggregate the data.

According to some embodiments, at 418, the development method includes searching the model repository by mapping “Method Selection” concepts with model meta-data to find re-useable/similar models and searching the visualization template repository by mapping “Method Selection” concepts with visualization meta-data to find re-useable/similar visualizations.

Referring to the searching of the model repository by mapping “Method Selection” concepts with model meta-data to find re-useable/similar models, in one example, a “Method Selection” action on the phase “predict demand” and a “Data Selection” on the phase “historical sales data” is mapped to pre-built training models that leverage historical sales transaction data to predict future demand. If no appropriate model is found, an analytic problem statement can be developed to drive the model development, and tagged with MUS concept and knowledge graph derived key words.

Referring to the searching of the visualization template repository by mapping “Method Selection” concepts with visualization meta-data to find re-useable/similar visualizations, in one example, if no appropriate model is found, a UX development requirement is developed to drive the visualization template development, where the visualization template is tagged with MUS concept and knowledge graph derived key words.

According to one or more embodiments, visualizations are trained in parallel with the training of the model. According to some embodiments, the models and visualizations are linked in the analytic task library, for example, if some model is determined to be relevant to a user's selection of entities, is there one or more visualizations that are automatically suggested (output).

According to at least one embodiment and referring to FIG. 5, the mining of analytic intent in complex interconnected data systems requires knowledge of the involved industries/disciplines (where) 501, jobs to be done (what) 502, and the data needed to inform analytic intent (how) 503. Due to the complexity and cost of uncovering insights within data rich industries, answering narrow business questions may be difficult. According to some embodiments, data visualization enables end users to explore data to answer some adjacent questions.

According to at least one embodiment and referring to FIG. 6, the analytic intent 601 describes an intention of an analytic to support an end user's ability to inform complex multivariate decisions, identify a complex pattern, or trend multivariate data across multiple dimensions. In FIG. 6, the analytic intent 601 is developed at 602-605, wherein at 602, for each industry, an affinity map of the industry's (e.g., industry “A”) applicable characteristics is determined, at 603 starter words are identified for each industry (e.g., as a set of commonly understood analytic operations/concepts linked to the respective industries), and at 604 and 605 a job to be accomplished and specific data are identified, respectively.

Referring to FIG. 6, uses at each contributing discipline (e.g., SME 606, Design 607, and Data 608) summarize/share their expertise regarding a given problem space 600, working within this collaborative framework the team's understanding is expanded across all three disciplines. For example, working within the collaborative framework, a team's understanding is expanded across all stakeholder disciplines. For example, as shown by the brackets in FIG. 6, a subject matter expert (SME) knows their industry and organization, but may have difficulty describing their goal or task in analytic terms from which the data scientist needs to create an appropriate model to support the SME's task. Choosing from starter words defined by a design professional, such as a user researcher, helps to more quickly bridge any communication gaps.

According to at least one embodiment and referring again to FIG. 7, the mapping is illustrated by the arrows 701. The mapping can take different forms depending on the tasks being performed. For example, the mapping can include querying the data (e.g., knowledge base 304 and analytic task library 305) and performing tasks such as aggregating, filtering, searching, etc. The concept-to-task mapping can be one-to-one, one-to-many, or many-to-many. For example, the <<industry>> concept informs a “Data Filtering” task at 702. In another example, the <<starter word>> and <<job to be done>> concepts together inform “Method Selection” at 703.

According to some embodiments, a set of sample MUS are developed (see FIG. 8). Example 801 illustrates a mapping in which <<Industry A>> is mapped to <<electronic chain>>, <<Starter Word>> is mapped to <<predict>>, <<Job to be Done>> is mapped to <SKU demand>> and <<Specific Data>> is mapped to <<historic sales data>>, where <<electronic chain>>, <<predict>>, etc., are mad-lib entities in the knowledge graph, and are used to create the MUS 802. Example 803 illustrates a mapping in which additional elements of the mad-lib sentence structure are mapped to entities in the knowledge graph, and are used to create the Mad-lib User Story (MUS) 804.

According to some embodiments, an enterprise design thinking session UI 900 is facilitated (see FIG. 9). According to some embodiments and referring to FIG. 10, the method prioritizes mad-libs entities 1001 from the design thinking session (see FIG. 9, 907), presents an initial constrained sentence case UI wizard 1002 and receives user selections for each of the concepts, and links to a dashboard that can answer a mad-lib question 1003 developed using the UI wizard 1002.

Recapitulation:

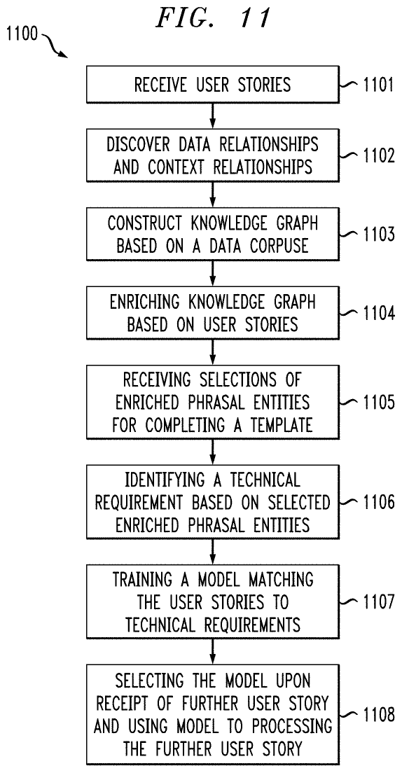

According to some embodiments of the present invention and referring to FIG. 11, a method for creating a question answering system 1100 includes receiving a plurality of user stories 1101, wherein each of the user stories is structured as a plurality of first phrasal entities within a template (MLSS); applying a Natural Language Processing (NLP) to discover first data relationships between the first phrasal entities and first context relationships between the first phrasal entities 1102; constructing a knowledge graph (KG) that captures second data relationships and second contextual relationships of a plurality of second phrasal entities extracted from a data corpus 1103; enriching the KG by linking the first phrasal entities to the second phrasal entities to form a plurality of enriched phrasal entities in the KG 1104; receiving a selection of ones of the enriched phrasal entities for completing a story template 1105; identifying a technical requirement based on the selection of the ones of the enriched phrasal entities 1106; and training at least one model matching at least one of the user stories to the technical requirement, wherein the model is stored in an analytic task library 1107. According to some embodiments, the model can be selected upon receipt of a further user story and used to answer, or prepare a reply to, a corresponding technical requirement 1108.

Recapitulation:

According to one or more embodiments of the present application, a computer-implemented method for creating a question answering system, the method comprises receiving a plurality of user stories, wherein each of the user stories is structured as a first plurality of phrasal entities within a template (MLLSS), applying a Natural Language Processing (NLP) to discover first data relationships between the phrasal entities and first context relationships between the phrasal entities, constructing a knowledge graph (KG) that captures second data relationships and second contextual relationships of a second plurality of entities extracted from a data corpus, enriching the KG by linking the first phrasal entities to the second entities to form a plurality of enriched phrasal entities in the KG, receiving a selection of ones of the enriched phrasal entities for completing a story template, identifying a technical requirement based on the selection of the ones of the enriched phrasal entities, and training a model matching at least one of the user stories to the technical requirement, wherein the model is stored in an analytic task library.

According to at least one embodiment, a computer-implemented method of operating a question answering system, the method comprises receiving a plurality of user stories, wherein each of the user stories is structured as a first plurality of phrasal entities within a template (MLLSS), discovering first data relationships between the phrasal entities, discovering first context relationships between the phrasal entities, accessing a knowledge graph (KG) that captures second data relationships and second contextual relationships of a second plurality of entities, enriching the KG by linking the first phrasal entities to the second entities to form a plurality of enriched phrasal entities in the KG, providing a display of select ones of the enriched phrasal entities, and receiving a selection of ones of the enriched phrasal entities displayed, wherein the selected enriched phrasal entities complete a story template.

The methodologies of embodiments of the disclosure may be particularly well-suited for use in an electronic device or alternative system. Accordingly, embodiments of the present invention may take the form of an entirely hardware embodiment or an embodiment combining software and hardware aspects that may all generally be referred to herein as a “processor,” “circuit,” “module” or “system.”

Furthermore, it should be noted that any of the methods described herein can include an additional step of providing a computer system for organizing and servicing resources of the computer system. Further, a computer program product can include a tangible computer-readable recordable storage medium with code adapted to be executed to carry out one or more method steps described herein, including the provision of the system with the distinct software modules.

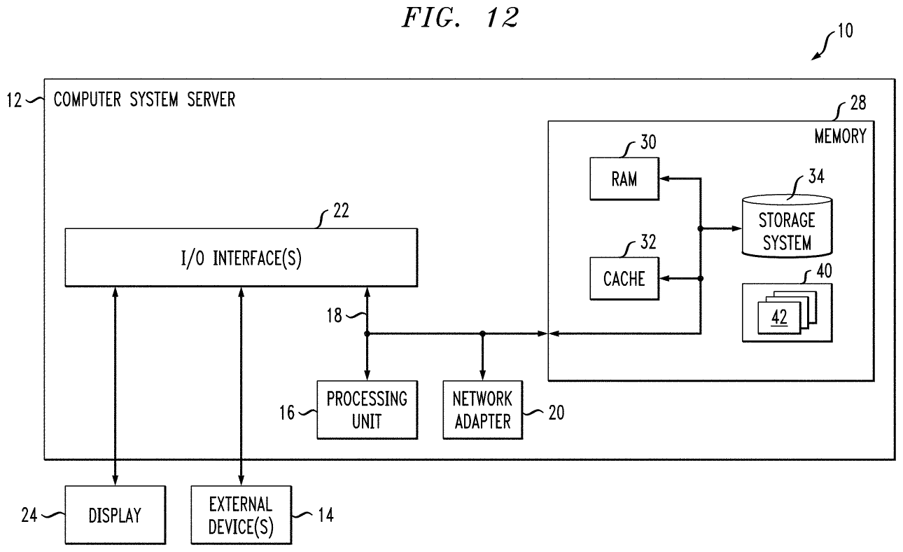

One or more embodiments of the invention, or elements thereof, can be implemented in the form of an apparatus including a memory and at least one processor that is coupled to the memory and operative to perform exemplary method steps. FIG. 12 depicts a computer system that may be useful in implementing one or more aspects and/or elements of the invention, also representative of a cloud computing node according to an embodiment of the present invention. Referring now to FIG. 12, cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 12, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, and external disk drive arrays, RAID systems, tape drives, and data archival storage systems, etc.

Thus, one or more embodiments can make use of software running on a general purpose computer or workstation. With reference to FIG. 12, such an implementation might employ, for example, a processor 16, a memory 28, and an input/output interface 22 to a display 24 and external device(s) 14 such as a keyboard, a pointing device, or the like. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory) 30, ROM (read only memory), a fixed memory device (for example, hard drive 34), a removable memory device (for example, diskette), a flash memory and the like. In addition, the phrase “input/output interface” as used herein, is intended to contemplate an interface to, for example, one or more mechanisms for inputting data to the processing unit (for example, mouse), and one or more mechanisms for providing results associated with the processing unit (for example, printer). The processor 16, memory 28, and input/output interface 22 can be interconnected, for example, via bus 18 as part of a data processing unit 12. Suitable interconnections, for example via bus 18, can also be provided to a network interface 20, such as a network card, which can be provided to interface with a computer network, and to a media interface, such as a diskette or CD-ROM drive, which can be provided to interface with suitable media.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 16 coupled directly or indirectly to memory elements 28 through a system bus 18. The memory elements can include local memory employed during actual implementation of the program code, bulk storage, and cache memories 32 which provide temporary storage of at least some program code in order to reduce the number of times code must be retrieved from bulk storage during implementation.

Input/output or I/O devices (including but not limited to keyboards, displays, pointing devices, and the like) can be coupled to the system either directly or through intervening I/O controllers.

Network adapters 20 may also be coupled to the system to enable the data processing system to become coupled to other data processing systems or remote printers or storage devices through intervening private or public networks. Modems, cable modem and Ethernet cards are just a few of the currently available types of network adapters.

As used herein, including the claims, a “server” includes a physical data processing system (for example, system 12 as shown in FIG. 12) running a server program. It will be understood that such a physical server may or may not include a display and keyboard.

One or more embodiments can be at least partially implemented in the context of a cloud or virtual machine environment, although this is exemplary and non-limiting. Reference is made back to FIGS. 1-2 and accompanying text. Consider, e.g., a database app in layer 66.

It should be noted that any of the methods described herein can include an additional step of providing a system comprising distinct software modules embodied on a computer readable storage medium; the modules can include, for example, any or all of the appropriate elements depicted in the block diagrams and/or described herein; by way of example and not limitation, any one, some or all of the modules/blocks and or sub-modules/sub-blocks described. The method steps can then be carried out using the distinct software modules and/or sub-modules of the system, as described above, executing on one or more hardware processors such as 16. Further, a computer program product can include a computer-readable storage medium with code adapted to be implemented to carry out one or more method steps described herein, including the provision of the system with the distinct software modules.

One example of user interface that could be employed in some cases is hypertext markup language (HTML) code served out by a server or the like, to a browser of a computing device of a user. The HTML is parsed by the browser on the user's computing device to create a graphical user interface (GUI).

Exemplary System and Article of Manufacture Details

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for creating a question answering system, the computer-implemented method comprising:
receiving a plurality of user stories, wherein each of the user stories is structured as a plurality of first phrasal entities within a template;
applying a Natural Language Processing (NLP) to discover first data relationships between the first phrasal entities and first context relationships between the first phrasal entities;
constructing a knowledge graph (KG) that captures second data relationships and second contextual relationships of a plurality of second phrasal entities extracted from a data corpus;
enriching the KG by linking the first phrasal entities to the second phrasal entities to form a plurality of enriched phrasal entities in the KG;
receiving a selection of ones of the enriched phrasal entities for completing a story template;
identifying a technical requirement based on the selection of the ones of the enriched phrasal entities; and
training a model matching at least one of the user stories to the technical requirement, wherein the model is stored in an analytic task library.

2. The method of claim 1, further comprising using the model to process data related to a technical requirement of a further user story.

3. The method of claim 1, wherein each of the enriched phrasal entities describes one of data selection, transformation, model formulation, and report design specifications.

4. The method of claim 1, further comprising training at least one visualization using the technical requirement.

5. The method of claim 4, further comprising:
storing the model and the at least one visualization in a searchable repository based on textual elements of the phrasal entities.

6. The method of claim 5, wherein the textual elements are each categorized as at least one of an industry type, a starter word, an actor's role, and a data type.

7. The method of claim 1, wherein the user story is stored in a library of user stories.

8. The method of claim 1, wherein the enriched phrasal entities are mapped to analytic tasks in the analytic task library.

9. The method of claim 1, wherein the technical requirement for the user stories is annotated with the analytic tasks.

10. The method of claim 1, further comprising updating the KG iteratively based on a received user feedback.

11. A computer-implemented method of operating a question answering system, the method comprising:
receiving a plurality of user stories, wherein each of the user stories is structured as a plurality of first phrasal entities within a template;
discovering first data relationships between the first phrasal entities;
discovering first context relationships between the first phrasal entities;
accessing a knowledge graph (KG) that captures second data relationships and second contextual relationships of a plurality of second phrasal entities;
enriching the KG by linking the first phrasal entities to the second phrasal entities to form a plurality of enriched phrasal entities in the KG;
providing a display of select ones of the enriched phrasal entities; and
receiving a selection of ones of the enriched phrasal entities displayed, wherein the selected enriched phrasal entities complete a story template.

12. The method of claim 11, wherein each of the enriched phrasal entities describes one of data selection, transformation, model formulation, and report design specifications.

13. The method of claim 11, further comprising:
identifying a technical requirement based on the selected enriched phrasal entities; and
training a model matching at least one of the user stories to the technical requirement, wherein the model is stored in an analytic task library.

14. The method of claim 13, further comprising using the model to process data related to a technical requirement of a further user story.

15. The method of claim 13, wherein the technical requirement for the user stories is annotated with the analytic tasks.

16. The method of claim 13, further comprising:
accessing data associated with the user stories; and
displaying the data associated with the user stories using at least one visualization selected according to the technical requirement.

17. The method of claim 16, further comprising:
storing the model and the at least one visualization in a searchable repository based on textual elements of the phrasal entities.

18. The method of claim 11, wherein the enriched phrasal entities are mapped to analytic tasks in an analytic task library.

19. A non-transitory computer readable storage medium comprising computer executable instructions which when executed by a computer cause the computer to perform a method of operating a question answering system, the method comprising:
receiving a plurality of user stories, wherein each of the user stories is structured as a plurality of first phrasal entities within a template;
discovering first data relationships between the first phrasal entities;
discovering first context relationships between the first phrasal entities;
accessing a knowledge graph (KG) that captures second data relationships and second contextual relationships of a plurality of second phrasal entities;
enriching the KG by linking the first phrasal entities to the second phrasal entities to form a plurality of enriched phrasal entities in the KG;
providing a display of select ones of the enriched phrasal entities; and
receiving a selection of ones of the enriched phrasal entities displayed, wherein the selected enriched phrasal entities complete a story template.

20. The computer readable storage medium of claim 19, wherein the method further comprises:
identifying a technical requirement based on the selected enriched phrasal entities; and
training a model matching at least one of the user stories to the technical requirement, wherein the model is stored in an analytic task library.

21. The computer readable storage medium of claim 20, wherein the method further comprises using the model to process data related to a technical requirement of a further user story.

22. The computer readable storage medium of claim 20, wherein the method further comprises:
accessing a data associated with the user stories; and
displaying the data associated with the user stories a using at least one visualization selected according to the technical requirement.

23. The computer readable storage medium of claim 19, wherein each of the enriched phrasal entities describes one of data selection, transformation, model formulation, and report design specifications.
